(19) United States
(12) Patent Application Publication
(10) Pub. No.: US 2003/0002564 A1
(43) Pub. Date: Jan. 2, 2003

(54) Method for controlling the operation of a positioning receiver, and an electronic device

(75) Inventors: Samuli Pietila, Tampere (FI); Harri Valio, Kammenniemi (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation, Espoo (FI)

(21) Appl. No.: 10/156,645

(22) Filed: May 24, 2002

(30) Foreign Application Priority Data
May 25, 2001 (FI) 20011095

(51) Int. Cl. H04B 15/00; H04K 1/00; H04L 27/30

(52) U.S. Cl. 375/142; 375/130; 375/147; 375/150

(57) ABSTRACT

The invention relates to a method for controlling the operation of a receiver. In the method, at least one spread spectrum modulated signal is received on at least two receiving channels, and a reference signal is formed on said at least two receiving channels by using a reference code corresponding to the code used in the modulation of the signal to be received. Further, in the method, the received signal is correlated with the reference signal. In the receiver, a set of correlators is used, and for at least one correlator of said set of correlators, a receiving channel is selected, wherein said at least one correlator is used in the correlation of the signal received on the receiving channel with the corresponding reference signal. The invention further relates to an electronic device and a wireless communication device comprising a receiver for receiving at least one spread spectrum modulated signal on at least two receiving channels, means for forming a reference code corresponding to the code used in the modulation of a signal to be received, means for forming a reference signal by using said reference code, and means for correlating the received signal with the reference signal. Said means for performing the correlation comprise a set of correlators and means for selecting at least one correlator from said set of correlators to be used on one of said at least two receiving channels.

### FIELD OF THE INVENTION

The present invention relates to a method for controlling the operation of a receiver, in which at least one spread spectrum modulated signal is received on at least two receiving channels, a reference signal is formed on said at least two receiving channels by using a reference code corresponding to the code used in the modulation of the signal to be received, and the received signal and the reference signal are correlated. The present invention further relates to a method for controlling the operation of a receiver, in which at least one spread spectrum modulated signal is received on at least two receiving channels, a reference signal is formed on said at least two receiving channels by using a reference code corresponding to the code used in the modulation of the signal to be received, and the received signal is correlated with the reference signal. The invention also relates to an electronic device comprising a receiver for receiving at least one spread spectrum modulated signal on at least two receiving channels, means for forming a reference code to correspond to the code used in the modulation of the signal to be received, means for generating a reference signal by using said reference code, and means for performing correlation of the received signal and the reference signal. The invention also relates to a wireless communication device comprising a receiver for receiving at least one spread spectrum modulated signal on at least two receiving channels, means for forming a reference code corresponding to the code used in the modulation of a signal to be received, means for forming a reference signal by using said reference code, and means for correlating the received signal with the reference signal.

### BACKGROUND OF THE INVENTION

In positioning systems based on satellite positioning, a positioning receiver attempts to receive the signals of at least four satellites in order to find out the position of the positioning receiver and time. An example of such a satellite positioning system is the GPS system (Global Positioning System), comprising a plurality of satellites orbiting the globe according to predefined orbits. These satellites transmit positioning data, on the basis of which the position of a satellite can be determined at each moment of time, in case the exact time data used in the satellite positioning system is known in the positioning receiver. In the GPS system, the satellites transmit a spread spectrum signal modulated with a code which is individual for each satellite. Thus, the positioning receiver can distinguish the signals transmitted by the different satellites from each other by using a reference code which corresponds to the satellite code and is generated locally in the positioning receiver.

A problem in such positioning systems based on satellite positioning is often the fact that the signal transmitted by a satellite is strongly attenuated when it arrives at the positioning receiver, wherein it is very difficult to distinguish the signal from background noise. The signal is attenuated e.g. by climatic conditions and obstacles, such as buildings and surrounding ground topography on the path of the signal. Also, the signal may come into the positioning receiver via a plurality of different routes which causes so-called multipath propagation and aggravates the acquisition of a desired signal in the positioning receiver, because the transmitted signal arrives at the receiver via different paths, for example straight from the satellite (line-of-sight) and also reflected. Due to this multipath propagation, the same signal is received as several signals with different phases. It is particularly difficult to perform positioning inside a building, because the building itself strongly attenuates the signal transmitted by satellites and, on the other hand, multipath propagation may be even stronger, because possibly reflected signals coming for example through a window are not necessarily as attenuated as signals coming straight through the roof. In this case, the receiver may misinterpret the signal propagation time and the satellite position at the moment of transmission of the signal, due to e.g. said lag in the signal propagation time, caused by the multipath propagation

Each operating satellite of the GPS system transmits a so-called L1 signal at the carrier frequency of 1575.42 MHz. This frequency is also indicated with 154f₀, where f₀=10.23 MHz. Furthermore, the satellites transmit another ranging signal at a carrier frequency of 1227.6 MHz called L2 , i.e. 120f₀. In the satellite, these signals are modulated with at least one pseudo random sequence. This pseudo random sequence is different for each satellite. As a result of the modulation, a code-modulated wideband signal is produced. The modulation technique used makes it possible to distinguish, in the receiver, the signals transmitted from different satellites, although the carrier frequencies used in the transmission are substantially the same. This modulation technique is called code division multiple access (CDMA). In each satellite, for modulating the L1 signal, the pseudo random sequence used is e.g. a so-called C/A code (Coarse/Acquisition code), which is a code from the family of the Gold codes. Each GPS satellite transmits a signal by using an individual C/A code. The codes are formed as a modulo-2 sum of two 1023-bit binary sequences. The first binary sequence G1 is formed with a polynome X¹⁰+X³+1, and the second binary sequence G2 is formed by delaying the polynome X¹⁰+X⁹+X⁸+X⁶+X³+X²+1 in such a way that the delay is different for each satellite. This arrangement makes it possible to produce different C/A codes by identical code generators. The C/A codes are thus binary codes whose chipping rate in the GPS system is 1.023 MHz. The C/A code comprises 1023 chips, wherein the iteration time (epoch) of the code is 1 ms. The carrier of the L1 signal is further modulated by navigation information at a bit rate of 50 bit/s. The navigation information comprises information about the “health”, orbit, time data of the satellite, etc.

To detect the signals of the satellites and to identify the satellites, the receiver must perform acquisition, whereby the receiver searches for the signal of each satellite at the time and attempts to be synchronized and locked to this signal so that the data transmitted with the signal can be received and demodulated.

The positioning receiver must perform the acquisition e.g. when the receiver is turned on and also in a situation in which the receiver has not been capable of receiving the signal of any satellite for a long time. Such a situation can easily occur e.g. in portable devices, because the device is moving and the antenna of the device is not always in an optimal position in relation to the satellites, which impairs the strength of the signal coming into the receiver.

Almost all known GPS receivers utilize correlation methods for acquisition of the code as well as for tracking. Reference codes ref(k), i.e. the pseudo random sequences for different satellites are stored or generated locally in the positioning receiver. A received signal is subjected to conversion to an intermediate frequency (down conversion), after which the receiver multiplies the received signal with the stored pseudo random sequence. The signal obtained as a result of the multiplication is integrated or low-pass filtered, wherein the obtained result is information on whether the received signal contained a signal transmitted by a satellite. The multiplication is iterated in the receiver so that the phase of the pseudo random sequence stored in the receiver is shifted each time. The correct phase is determined from the correlation result preferably so that when the correlation result is the greatest, the correct phase has been found. Thus, the receiver is correctly synchronized with the received signal. After the code acquisition has been completed, the next steps are frequency tuning and phase locking.

The above-mentioned acquisition and frequency control process must be performed for each signal of a satellite which is received in the receiver. Some receivers may have several receiving channels, wherein an attempt is made on each receiving channel to acquire the signal of one satellite at a time and to find out the information transmitted by this satellite.

A typical GPS receiver comprises three correlators for each receiving channel. With the three correlators, it is only possible to cover the time of one chip (1 μs). In such a receiver, the correlators are typically early (E), i.e. leading a correlation peak; prompt (P), i.e. at the correlation peak; and late (L), i.e. behind the correlation peak. However, if there is, for example, considerable multipath interference in the satellite signal to be received on any channel, said three correlators will not be sufficient. This problem could be solved by providing a greater number of correlators for each channel. As a result, however, the structure of the receiver will become more complex and larger in size. Furthermore, the power consumption of the receiver may increase to a significant degree. For example, if there are 12 channels and 10 correlators are provided for each channel, the total number of the correlators will be as high as 120. However, most of these correlators may be redundant for a long time during the operation of the receiver.

In a prior art receiver, it is possible to set all the channels of such a receiver provided with fixed correlators to search for the same satellite. In this case, however, the channels must be re-initialized, which means that the reference codes must be timed so that different channels search for different chips in different parts of the satellite signal. This takes time, and moreover, the channels cannot receive signals from other satellites during the time of searching for one satellite.

### SUMMARY OF THE INVENTION

It is an aim of the present invention to provide a method for controlling the operation of a receiver in such a way that the operation of the receiver can be adjusted to be as advantageous as possible in view of the receiving conditions at the time, without the need to complicate the structure of the receiver to a significant degree. It is another aim of the invention to provide a relatively simple receiver whose operation can be adjusted according to the receiving conditions. More precisely, the method according to the present invention is primarily characterized in that a set of correlators is used in the receiver, and that a receiving channel is selected for at least one correlator within said set of correlators, wherein said at least one correlator is used in the correlation of the signal received on the receiving channel with the respective reference signal. The method according to another embodiment of the present invention is primarily characterized in that a set of correlators is used in the receiver, a receiving channel is selected for at least one correlator within said set of correlators, said at least one correlator is used in the correlation of the signal received on the receiving channel with the respective reference signal, the received signal is delayed, and a part of the delayed signal is selected to be conducted to at least one correlator selected for each channel, and to search for a correlation peak, signals formed by the correlators selected for the channel are examined, and if no correlation peak has been found, another part of the delayed signal is selected for the correlation, wherein the steps of examining and selecting are iterated, until a correlation peak is found. The electronic device according to the present invention is primarily characterized in that said means for performing the correlation comprise a set of correlators, and means for selecting at least one correlator from said set of correlators to be used on any of said at least two receiving channels. The electronic device according to another embodiment of the present invention is primarily characterized in that said means for performing the correlation comprise a set of correlators and means for selecting at least one correlator from said set of correlators to be used on one of said at least two receiving channels, the electronic device further comprising at least one delay line for delaying the received signal, means for selecting a part of the delayed signal to be conducted to at least one correlator selected for each channel, means for searching for a correlation peak by examining the signals formed by the correlators selected for the channel, and means for iterating the steps of examining and selecting, if no correlation peak has been found, wherein another part of the delayed signal is arranged to be selected for the correlation. The wireless communication device according to the present invention is primarily characterized in that said means for performing the correlation comprise a set of correlators and means for selecting at least one correlator from said set of correlators to be used on one of said at least two receiving channels. The wireless communication device according to another embodiment of the present invention is primarily characterized in that said means for performing the correlation comprise a set of correlators and means for selecting at least one correlator from said set of correlators to be used on one of said at least two receiving channels, the electronic device further comprising at least one delay line for delaying the received signal, means for selecting a part of the delayed signal to be conducted to at least one correlator selected for each channel, means for searching for a correlation peak by examining the signals formed by the correlators selected for the channel, and means for iterating the steps of examining and selecting, if no correlation peak has been found, wherein another part of the delayed signal is arranged to be selected for the correlation.

Considerable advantages are achieved by the present invention when compared with methods and positioning receivers of prior art. In the method according to the present invention, the operation of the positioning receiver can be controlled in such a way that on each receiving channel, the number of correlators can be adjusted on the basis of the receiving conditions on the channel; consequently, variations in the signal strength and the effect of possible multipath-propagated signals on the reception can be eliminated better than in receivers of prior art. Acquisition can thus be made also in a situation in which the signal strength is relatively weak and the signal is noisy on some channels. When applying the method of the invention, the structure of the positioning receiver can be made simpler than in solutions of prior art, in which a fixed number of correlators is used on each channel. Furthermore, when applying the method of the invention, it is possible to perform acquisition of the signal faster, because the number of correlators used on a channel can be increased on such a channel in which re-acquisition is necessary.

### DESCRIPTION OF THE DRAWINGS

In the following, the present invention will be described in more detail with reference to the appended drawings, in which

FIG. 1 shows an electronic device according to a preferred embodiment of the invention in a reduced block chart,

FIG. 2 shows an acquisition block according to an advantageous embodiment of the invention in a reduced block chart, and

FIG. 3 shows an acquisition block according to another advantageous embodiment of the invention in a reduced block chart.

### DETAILED DESCRIPTION OF THE INVENTION

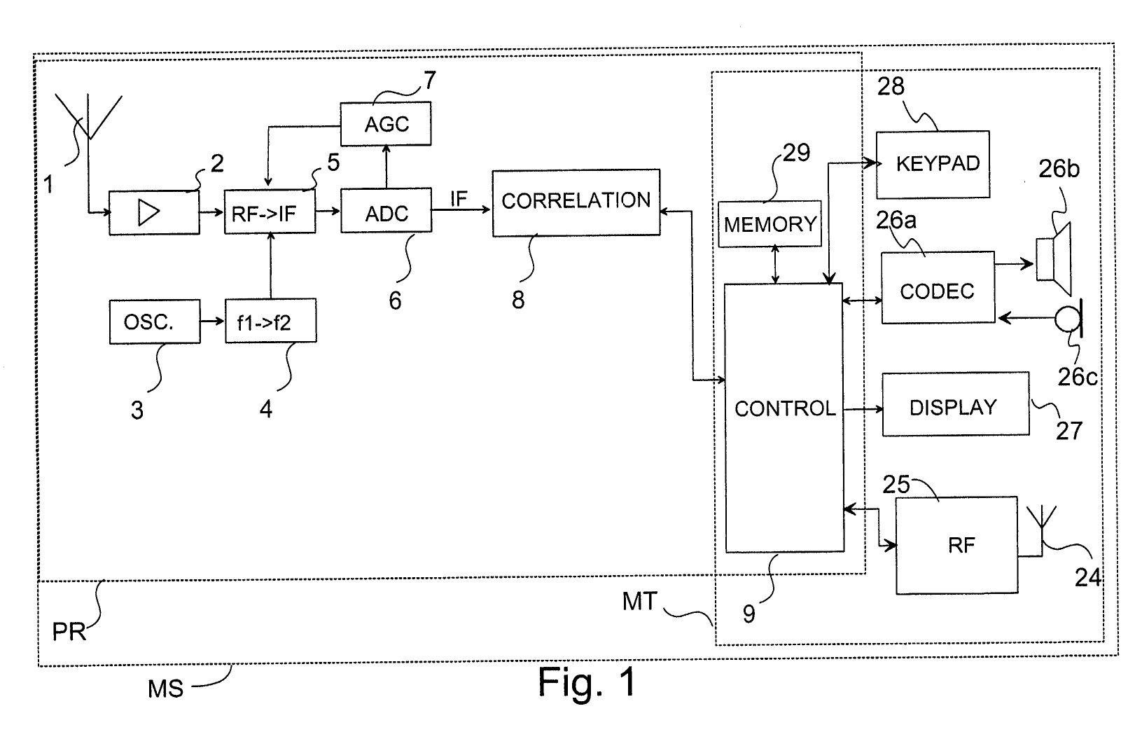

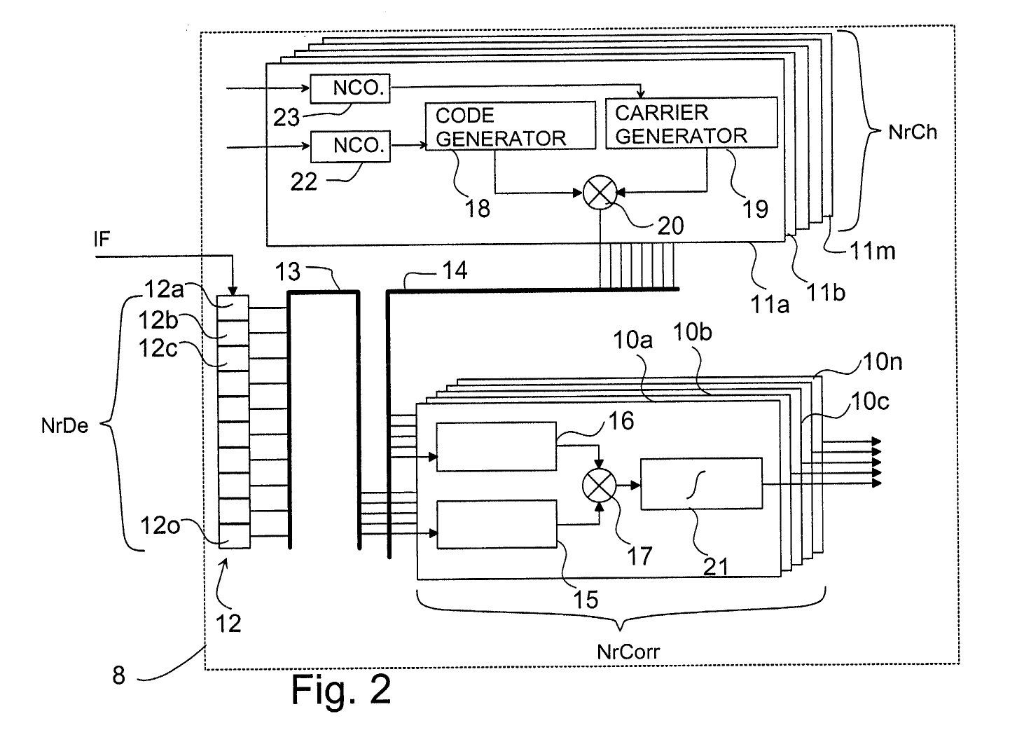

In the following, the operation of a receiver PR according to an advantageous embodiment of the invention will be described with reference to the reduced block charts of FIGS. 1 and 2. A spread spectrum modulated signal to be received via an antenna 1 is amplified in a high-frequency amplifier 2 and is modified, by means of a clock signal formed by a clock generator 3 and a frequency synthesizer 4, preferably to an intermediate frequency or directly to baseband in a converter block 5. At this stage, the signal is advantageously still in analog format, wherein it is converted to a digital signal in an analog-to-digital converter 6. The analog-to-digital converter 6 provides not only a digital receiving signal but also a control to an automatic gain control (AGC) block 7 which attempts to level out variations in the strength of the received signal in a way known as such. The digital signal converted to an intermediate frequency or to baseband is led to one or more digital monitoring blocks 8 to perform conversion of the digital signal to two signals with different phases (I/Q), multiplication with a reference code, and correlation. The signals formed in the monitoring block 8 are further conducted to a control block 9 to find out the code phase and the frequency shift of the received signal on the basis of the correlation. The control block 9 forms feedback to the monitoring block 8, to adjust the code phase of the reference code and a carrier generator 23, if necessary. After the code phase and the frequency shift have been determined, that is, the receiver has tracked the signal to be received, it is possible to start demodulation and storage of the navigation information transmitted in the signal, if necessary. The control block 9 preferably stores navigation information in a memory 29.

An advantageous structure of the digital monitoring block 8 is presented in the block chart of FIG. 2. The monitoring block 8 comprises a set of correlator blocks 10a-10n as well as a set of code and carrier blocks 11a-11m. Thus, each code and carrier block 11a-11m forms one receiving channel. Thus, the number of the code and carrier blocks 11a-11m is affected, for example, by the number of satellites whose signals are to be received simultaneously by the positioning receiver. The number of correlator blocks 10a-10n is, in turn, affected by the minimum number of correlators available on each receiving channel and by the desired total number of correlators. For example, if at least three correlators are to be used on each channel, the number of correlators required is three times the number of channels. However, it is obvious that the invention is not limited solely to applications of this kind, but the number of correlator blocks can also be determined on another basis. The figure only shows the structures of one correlator block 10a and one code and carrier block 11a, but the structures of the other correlator blocks 10b-10n as well as the other code and carrier blocks 11b-11m are, for their essential parts, similar in function. Furthermore, the monitoring block has substantially identical functional parts for the processing of the bicomponent signal (I, Q), but for the sake of clarity, FIG. 2 only shows the functional parts which are essential for describing the invention, with respect to a single signal component only.

The processing of the received signal is preferably performed in the monitoring block 8 according to an advantageous embodiment of the invention. The digital signal converted to an intermediate frequency or a baseband is conducted to a delay line 12. The output lines of the delay blocks 12a-12o of the delay line 12 are connected to a first signal bus 13. Furthermore, in each correlator block 10a-10n of the monitoring block 8, each signal line of this first signal bus is connected to one input line of a first selection block 15. Thus, in the first selection block 15, any input line of the first selection block 15 can be selected as the output signal of the selection block.

The code and carrier block 11a-11m comprises a reference code generator 18 to form a reference code which corresponds to the code used by the satellite which transmits the signal received by said code and carrier block 11a-11m. The code and carrier block 11a-11m further comprises a carrier generator 19 to find out the frequency shift of the signal to be received. The signal generated by the carrier generator 19 and the reference code generated by the reference code generator are multiplied in a multiplier block 20, after which the signal obtained as the product is conducted to a second signal bus 14. Via the second signal bus 14, the signal formed by the multiplier block 20 can be conducted to the second selection block 16 in each correlator block 10a-10n, wherein the second selection block in each correlator block can select, from the signals of the multiplier blocks 20 of the different code and carrier blocks 11a-11m, the signal required at the time to be coupled to the output of the second selection block 16. The output of the second selection block is connected to the first input of the code multiplier 17, and the input line of the first selection block 15 is connected to the second input of the code multiplier 17.

In the code multiplier 17, the signal selected for the output line of the first selection block 15 is multiplied by the signal selected for the output line of the second selection block 16. The signal formed in the code multiplier is advantageously integrated in an integrator 21, preferably for a predetermined time, after which the signal generated by the integrator 21 is conducted to the control block 9 for analysis.

By means of the first 15 and second 16 selection blocks, however, each channel can be allocated a given number of correlators according to the receiving conditions on the different channels. For example, when starting the positioning, the receiving conditions can be assumed to be substantially identical on all channels, unless the positioning receiver has previously determined and updated information about the receiving conditions. Thus, the control unit 9 preferably sets the same number of correlator blocks 10a-10n for each channel, preferably three for each channel. This can be performed, for example, so that the control block 9 allocates the first three correlator blocks 10a, 10b, 10c to the first channel, i.e. to the first code and carrier block 11a. In a corresponding manner, the next three correlator blocks are allocated to the second code and carrier block 11b, and so on. In addition, the selection must still be made in each correlator block, from which location of the delay line 12 the signal is taken into the respective correlator block. At this starting stage, the signal can be conducted, for example, from the first delay element 12a of the delay line into the first correlator block, from the second delay element 12b of the delay line into the second correlator block, and from the third delay element of the delay line into the third correlator block. In a corresponding manner, the signal can be conducted from the first delay element 12a of the delay line into one correlator block of the second channel, from the second delay element 12b into the next correlator block of the second channel, and from the third delay element 12c into the yet following correlator block of the second channel. Corresponding steps can also be taken on the other channels.

The delay in each delay block 12a-12o of the delay line can be preferably selected so that a sufficient resolution is achieved at the correlation stage. For example, each delay block produces a delay of one sample, which corresponds, for example at a sample frequency of 2 MHz, to a delay of 0.5 μs. It is obvious that also other delay values and sample frequencies can be applied in connection with the present invention.

In addition to the selection of the signals taken from the delay line 12, the correlator block 10a-10n must select the signal generated by a code and carrier block 11a-11m for the correlation of the received signal with the signal formed by the code and carrier block 11a-11m. This is performed so that in the second selection block 16 of the correlator blocks selected for a given channel, the signal of the code and carrier block 11a-11m corresponding to the respective channel is selected as the output signal. In this example, this means that in the second selection block 16 of the correlator blocks 10a, 10b, 10c selected for the first channel, the output signal is selected to be the signal of the first code and carrier block 11a. In a corresponding manner, the output signal of the second selection block 16 of the correlator blocks selected for the second channel is selected to be the signal of the second code and carrier block 11b, and so on.

The selection blocks 15, 16 used can be, for example, binary selection blocks (multiplexers), in which one input line at a time can be connected to the output line. The selection functions of the selection blocks 15, 16 can be controlled in a way known as such, for example in such a way that the control block 9 sets a given binary digit in the control input of the selection block, wherein the signal in the input line corresponding to the set binary digit is connected to the output line. The number of bits in this binary digit depends, for example, on the number of available input lines, which is known as such.

In the control block 9, it is determined, on the basis of the output signals of the different integration blocks, e.g. whether the code phase of the reference code is leading (E, early), behind (L, late) or in the same phase (P, prompt) as the code phase of the received signal. On the basis of this determination, the control block 9 adjusts the frequency of a numerically controlled oscillator 22 controlling the reference code generator 18, and/or selects, from the delay line 12, the different delay blocks from which the signal is taken into the correlator blocks of the respective receiving channel. Furthermore, the control block 9 determines the frequency shift, if any, and adjusts the frequency of a numerically controlled oscillator 23. On one channel of the monitoring block 8, signal processing can be performed for one signal at a time, wherein to receive e.g. four signals simultaneously, there must be at least four channels in the monitoring blocks. It is obvious that the receiver shown in FIGS. 1 and 2 is only an example embodiment, but the present invention is not limited for use in this receiver only.

If, on any channel, the receiver cannot perform signal acquisition, or if the receiver loses the signal e.g. after the signal has been significantly attenuated due to an obstacle on the signal path, it is possible, in the method according to an advantageous embodiment of the invention, to take the following steps. The control block 9 determines if there are vacant correlator blocks, wherein these vacant correlator blocks can be allocated to such a channel on which acquisition is not possible or signal has been lost. On the other hand, from channels on which the signal quality is relatively good, part of the correlator blocks selected for such a channel can be allocated to another channel for acquisition. Thus, this channel will have more correlator blocks available, wherein a longer time can be selected from the delay line to perform the correlation measures. On the basis of the signals formed by several correlator blocks, the control block 9 may try to determine if the acquisition failure is due to e.g. multipath propagation. Thus, when several correlator blocks are used, it is easier to distinguish multipath propagated signals from each other and to find the correct code phase and the frequency shift. Due to multipath-propagated signals, it may in some cases be necessary to perform correlation on one channel at intervals of about 0.1 to 0.2 μs, wherein the period of one chip (˜1 μs) can be covered by 5 to 10 correlators. If there is a sufficient number of correlator blocks available, it is possible to achieve, with e.g. about 50 correlator blocks, a correlation time interval which is sufficiently dense and temporally sufficiently long in many situations. Thus, by the method according to the present invention, correlator blocks can be allocated to different channels according to the need at the time, and the total number of correlator blocks can thus be kept reasonable.

The method of the invention can also be applied in a situation in which all the receiving channels are set to search for a given satellite. Thus, because all the correlator blocks can be set to receive the signal of this satellite to be searched for, the search area can be prolonged. However, in solutions of prior art, in which a fixed number of correlators is allocated to each channel, searching can only be performed for a limited area.

In addition, the control block 9 can monitor variations in the positioning which is to be performed on the basis of the different receiving channels. If significant deviations are detected on any channel, the control block 9 may try to correct the situation by allocating several correlator blocks to such a channel. In some situations, this may improve the operation of the receiving channel and thereby reduce inaccuracy in the positioning.

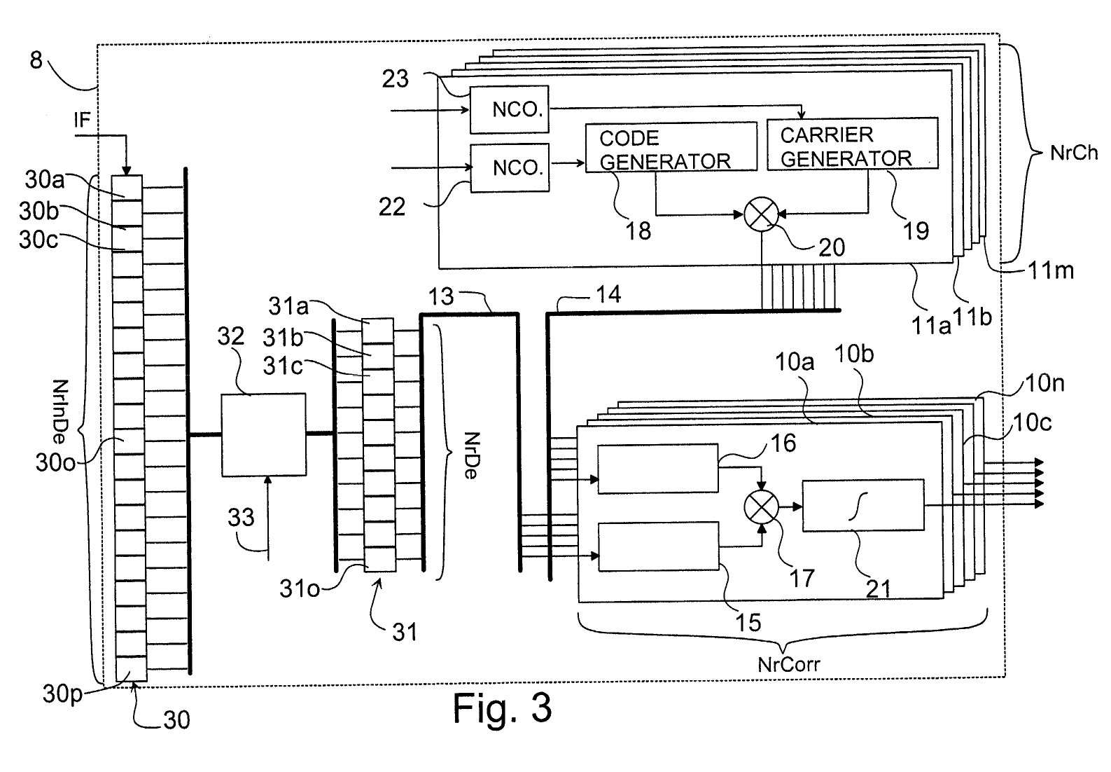

FIG. 3 shows the structure of a monitoring block 8 according to another advantageous embodiment of the invention in a reduced block chart. The difference in this embodiment from the monitoring block 8 of FIG. 2 lies primarily in that the delay line 12 is divided into at least a first 30 and a second delay line 31. Thus, in a third selection block 32, signals can be selected from the first delay line to be transferred to the second delay line. By means of the two delay lines 30, 31 and the third selection block, it is possible to extend the delay line 12 and still to keep the size of the first selection blocks 15 of the correlator blocks 10 within reasonable limits.

The output line of each delay block 30a-30p in the first delay line 30 is connected to one input line of the third selection block 32. In the first delay line 30, the number of delay blocks 30a-30p is set greater than the number of delay blocks 31a-31o in the second delay line. In a corresponding manner, the number of delay blocks 31a-31o in the second delay line 31 can be set, for example, equal to the number of delay blocks 12a-12o in the delay line 12 used in the monitoring block according to the first advantageous embodiment of the invention. Each output line of the third selection block 32 is connected to one delay block 31a-31o in the second delay line 31. Thus, information is transferred in parallel form from the first delay line 30 by means of the third selection block 32 into the second delay line 31.

The processing of the received signal is performed in the monitoring block 8 according to this second advantageous embodiment of the invention in the following way. The digital signal converted to an intermediate frequency or a baseband is conducted to the first delay line 30. After this, the information is transferred in such a way that a numerical value is set in the selection lines 33 of the third selection block 32, to indicate the desired location in the first delay line 30. As a result of this, the signals of the delay blocks of the first delay line 30 are coupled, from this location selected by the selection lines 33 (e.g. delay blocks 30a-30o), to the output lines of the third selection block 32, and the signals are stored in the delay blocks 31a-31o of the second delay line 31. Consequently, the third selection block 32 can be used to select a number, corresponding to the length of the second delay line, of available delay blocks in the first delay line 30. After the necessary information has been transferred to the second delay line 31, the information can be transferred further to the correct correlator block 1oa-10n, as presented in connection with the description on the operation of the monitoring block 8 according to the first advantageous embodiment of the invention. After this, it is possible to repeat the above-presented operations, by which information is transferred from the first delay line 30 to the second delay line 31 and further to a specific correlator block 10a-10 n.

In other respects, the operation of the monitoring block according to the second advantageous embodiment of the present invention corresponds to the description on the operation presented above in this specification, wherein its more detailed discussion in this context will be rendered unnecessary.

The receiver PR preferably also comprises means for performing the functions of a wireless communication device, such as a second antenna 24, a radio part 25, audio means, such as a codec 26a, a speaker 26b and a microphone 26c, a display 27, a keypad 28, and a memory 29. The control block 9 can be at least partly common to perform the functions of the receiver PR and to perform the functions of the wireless communication device, or separate processors or the like can be used for these functions.

Although the invention has been described above by using, as an example of a spread-spectrum modulated signal, a spread-spectrum modulated signal used in a satellite system and modulated with an individual code, the invention can also be applied in other systems which use spread spectrum modulation and in which the different states of the binary and other information are modulated with symbols.

It is obvious that the present invention is not limited solely to the above-presented embodiments, but it can be modified within the scope of the appended claims.

1. A method for controlling the operation of a receiver, in which at least one spread spectrum modulated signal is received on at least two receiving channels, a reference signal is formed on said at least two receiving channels by using a reference code corresponding to the code used in the modulation of the signal to be received, and the received signal is correlated with the reference signal, wherein a set of correlators is used in the receiver, and that a receiving channel is selected for at least one correlator within said set of correlators, wherein said at least one correlator is used in the correlation of the signal received on the receiving channel with the respective reference signal.

2. The method according to claim 1, wherein the number of correlators required for the correlation on each receiving channel is determined, and the number of correlators which corresponds to the need determined for each channel is selected from said set of correlators.

3. The method according to claim 1, wherein to produce said reference signal, a carrier signal is generated, which is multiplied with said reference code.

4. The method according to claim 1, wherein the received signal is delayed, and a part of the delayed signal is selected to be conducted to at least one correlator selected for each channel.

5. A method for controlling the operation of a receiver, in which at least one spread spectrum modulated signal is received on at least two receiving channels, a reference signal is formed on said at least two receiving channels by using a reference code corresponding to the code used in the modulation of the signal to be received, and the received signal is correlated with the reference signal, wherein a set of correlators is used in the receiver, a receiving channel is selected for at least one correlator within said set of correlators, said at least one correlator is used in the correlation of the signal received on the receiving channel with the respective reference signal, the received signal is delayed, and a part of the delayed signal is selected to be conducted to at least one correlator selected for each channel, and to search for a correlation peak, signals formed by the correlators selected for the channel are examined, and if no correlation peak has been found, another part of the delayed signal is selected for the correlation, wherein the steps of examining and selecting are iterated, until a correlation peak is found.

6. An electronic device comprising a receiver for receiving at least one spread spectrum modulated signal on at least two receiving channels, means for forming a reference code corresponding to the code used in the modulation of a signal to be received, means for forming a reference signal by using said reference code, and means for correlating the received signal with the reference signal, wherein said means for performing the correlation comprise a set of correlators and means for selecting at least one correlator from said set of correlators to be used on one of said at least two receiving channels.

7. An electronic device according to claim 6, wherein it comprises means for determining the number of correlators required in the correlation on each receiving channel, and means for selecting, from said set of correlators, a number of correlators which corresponds to the need determined for each channel.

8. The electronic device according to claim 6, wherein the means for forming a reference signal comprise means for forming a carrier signal, and means for multiplying the carrier signal by said reference code.

9. The electronic device according to claim 6, wherein it comprises at least one delay line for delaying the received signal, and means for selecting a part of the delayed signal to be conducted to at least one correlator selected for each channel.

10. An electronic device comprising a receiver for receiving at least one spread spectrum modulated signal on at least two receiving channels, means for forming a reference code corresponding to the code used in the modulation of a signal to be received, means for forming a reference signal by using said reference code, and means for correlating the received signal with the reference signal, wherein said means for performing the correlation comprise a set of correlators and means for selecting at least one correlator from said set of correlators to be used on one of said at least two receiving channels, the electronic device further comprising at least one delay line for delaying the received signal, means for selecting a part of the delayed signal to be conducted to at least one correlator selected for each channel, means for searching for a correlation peak by examining the signals formed by the correlators selected for the channel, and means for iterating the steps of examining and selecting, if no correlation peak has been found, wherein another part of the delayed signal is arranged to be selected for the correlation.

11. A wireless communication device comprising a receiver for receiving at least one spread spectrum modulated signal on at least two receiving channels, means for forming a reference code corresponding to the code used in the modulation of a signal to be received, means for forming a reference signal by using said reference code, and means for correlating the received signal with the reference signal, wherein said means for performing the correlation comprise a set of correlators and means for selecting at least one correlator from said set of correlators to be used on one of said at least two receiving channels.

12. A wireless communication device comprising a receiver for receiving at least one spread spectrum modulated signal on at least two receiving channels, means for forming a reference code corresponding to the code used in the modulation of a signal to be received, means for forming a reference signal by using said reference code, and means for correlating the received signal with the reference signal, wherein said means for performing the correlation comprise a set of correlators and means for selecting at least one correlator from said set of correlators to be used on one of said at least two receiving channels, the electronic device further comprising at least one delay line for delaying the received signal, means for selecting a part of the delayed signal to be conducted to at least one correlator selected for each channel, means for searching for a correlation peak by examining the signals formed by the correlators selected for the channel, and means for iterating the steps of examining and selecting, if no correlation peak has been found, wherein another part of the delayed signal is arranged to be selected for the correlation.
